(19) United States
(12) Patent Application Publication
(10) Pub. No.: US 2010/0130157 A1
(43) Pub. Date: May 27, 2010

(54) RF ISOLATION OF LOW COST SWITCH USING SHUNT DIODE

(76) Inventor: David Glen White, Indianapolis, IN (US)

Correspondence Address: Robert D. Shedd, Patent Operations;THOMSON Licensing LLC, P.O. Box 5312, Princeton, NJ, 08543-5312, US

(21) Appl. No.: 12/451,245

(22) PCT Filed: May 9, 2008
(86) PCT No.: PCT/US08/05954

§ 371 Date: Nov. 2, 2009

Related U.S. Application Data
(60) Provisional application No. 60/928,468, filed on May 9, 2007.

(51) Int. Cl. H04B 1/26

(52) U.S. Cl. 455/323

(57) ABSTRACT

The method and apparatus according to the present invention teaches a way to employ a pair of inexpensive switch IC's by improving isolation using a tuned diode shunt on the potential leakage path that exists between the two inputs when the IRD is in the legacy LNB Mode. In particular, the present invention teaches a method and apparatus of providing a signal path between a first input and a second signal processor. The second signal processor can further be coupled to a second input. When the second processor is coupled to the second input, the signal path is decoupled from the second processor and coupled to ground using a pin diode.

### CROSS REFERENCE TO RELATED APPLICATION

This application claims priority to and all benefits accruing from a provisional application filed in the United States Patent and Trademark Office on May 9, 2008, and there assigned Ser. No. 60/928,468.

### BACKGROUND OF THE INVENTION

1. Field of the Invention

The present invention generally relates to signal communications, and more particularly, to an architecture and protocol for enabling signal communications between a frequency translation apparatus, which may be referred to herein as a frequency translation module (FTM), and an integrated receiver-decoder (IRD) or between a low noise block converter (LNB) and an IRD.

2. Background Information

In a satellite broadcast system, one or more satellites receive signals including audio and/or video signals from one or more earth-based transmitters. The satellite(s) amplify and rebroadcast these signals to signal receiving equipment at the dwellings of consumers via transponders that operate at specified frequencies and have prescribed bandwidths. Such a system includes an uplink transmitting portion (i.e., earth to satellite(s)), an earth-orbiting satellite receiving and transmitting portion, and a downlink portion (i.e., satellite(s) to earth).

In dwellings that receive signals from a satellite broadcast system, signal receiving equipment may be used to frequency shift portions of a frequency band or the entire broadcast spectrum of the satellite(s), and frequency stack the resultant output onto a single coaxial cable. However, as the number of satellites within a satellite broadcast system increases, and with the proliferation of high definition satellite channels, a point will be reached where the total bandwidth required to accommodate all of the satellites will exceed the transmission capability of the coaxial cable. It has become necessary for the satellite decoder industry to implement more satellite slots into their distribution systems. To provide for the increased number of satellite slot transmissions a more elaborate means for satellite configurations selection is required.

Present day satellite decoders are specified to operate in two modes: an “LNB Mode” where satellite inputs are connected to traditional LNB outdoor units and feed their signals to independent tuners and an “FTM Mode” where all of the satellite tuners are fed from a single input. Present day satellite decoders must currently operate in both modes to provide time for the satellite television industry to transition from the legacy LNB method to the newer FTM method.

The legacy LNB method couples a single LNB to a single tuner. In multiple LNB situations, each LNB is coupled to its own dedicated tuner and each LNB system operates independently. Circuitry implemented with the tuner controls satellite RF band selection by voltage level and a superimposed, 600 mvp-p, 22 kHz tone or lack of tone. Tone selection is accomplished by either a constant tone or a Pulse Width Modulated (PWM) tone. The industry standard for the PWM tone is called DiSEqC and is defined in the Eutelsat DiSEqC Bus Functional Specification. The two stage, output voltage (13 or 18 volts) is typically used to select the polarity of incoming satellite signals and the tone selects various satellite slots in space.

The FTM method uses a UART controlled 2.3 MHz, Frequency Shift Key (FSK) modulation scheme to communicate selection commands to the satellite configuration switch. The FTM switch is designed to select a satellite signal transponder from a host of satellite receiver antennas and translate it, in frequency, to a single transponder band. This new frequency shifted transponder band is then sent to the satellite decoder box through the connecting coaxial cable.

Present day satellite decoder systems need the ability to switch between these two methods and operate in either mode without being disturbed by the other system. Previous attempts at creating a switch circuit with sufficient isolation have used an expensive high performance switch. The isolation performance of these switches however varied according to frequency. For example, these switches are capable of exceptional isolation (60-70 dB) at 950 MHz but tapers off to approximately 45 dB at 2150 MHz. The exceptionally wide bandwidth of a satellite IRD causes even these expensive switches to fail the isolation requirements. In this case, two expensive switches, one with better low frequency performance and one with better high frequency performance would be require to be used in series, with each switch compensating for the others shortcomings. This solution doubles an already expensive design option. A secondary disadvantage of this arrangement is that these types of switch IC's have two control lines that require an inverter on the second line. An alternative approach would be a much higher cost absorptive switch IC with approximately 60 dB isolation to help ensure margin in production. Cost is the primary issue and there might also be an issue with the crossover path picking up leakage RF from other parts of the circuit if it was not very carefully protected in the layout. Other attempts at meeting the isolation standard include using three or more low cost switches in series. The cost is lower than the approaches listed above, but obviously adds to the complexity. The switch IC's also add approximately 1 dB of insertion loss per IC as well as introduce additional gain taper due to stray inductance in the RF path.

A switch circuit is required to meet the above functionality and overcome the previously described shortcomings of previous attempts. The desired circuit must provide high levels of isolation between inputs when used in LNB Mode. As with any consumer electronics product, meeting design criteria in an economical manner is highly desirable. The present invention described herein addresses this and/or other problems.

### SUMMARY OF THE INVENTION

In accordance with an aspect of the present invention, an apparatus for controlling an signal path in a first mode of operation and a second mode of operation is disclosed. According to an exemplary embodiment, the apparatus comprises, a first input, a first signal processing circuit, a first switch, a signal path, and a splitter for coupling a signal from said input to said first signal processing circuit and said switch, said first switch being operative to couple said signal to said signal path during a first mode of operation, said first switch (34) being further operative to isolate said signal from said signal path during a second mode of operation; wherein said signal path is coupled to a source of reference potential during said second mode of operation and isolated from said source of reference potential during said first mode of operation

In accordance with another aspect of the present invention, a method for controlling a signal path in one of two operating modes is disclosed. According to an exemplary embodiment, the method comprises steps of receiving a first signal from a first source during a first mode of operation and a second mode of operation receiving a second signal from a second source during a second mode of operation, coupling said first signal to a first signal processor and a second signal processor during a first mode of operation, and coupling said first signal to said first signal processor and said second signal to said second signal processor and coupling a junction between said first source and said second signal processor to a source of reference potential during a second mode of operation.

In accordance with an aspect of the present invention, an apparatus for controlling an signal path in a first mode of operation and a second mode of operation is disclosed. According to an exemplary embodiment, the apparatus comprises, a signal path, said signal path being coupled between a signal source and a tuner during a first mode of operation and being isolated from said signal source and said tuner during a second mode of operation, wherein said signal path is further coupled to a source of reference potential during said second mode of operation and being isolated from said source of reference potential during said first mode of operation.

In accordance with another aspect of the present invention, a method for controlling a signal path in one of two operating modes is disclosed. According to an exemplary embodiment, the method comprises steps of coupling a first signal to a first signal processing circuit via a first signal path and a second signal processing circuit via a second signal path, receiving a control signal, coupling a second signal to said second signal processor via a third signal path in response to said control signal, isolating said second signal path from said second signal processing circuit in response to said control signal, and coupling said second signal path to a source of reference potential in response to said control signal.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram showing an exemplary environment for implementing the present invention;

FIG. 2 is a block diagram showing further details of the FTM of FIG. 1 according to an exemplary embodiment of the present invention;

FIG. 3 is a diagram showing further details of the FTM LNB switching circuit implementing a single diode according to an exemplary embodiment of the present invention;

FIG. 4 is a diagram showing further details of the FTM LNB switching circuit implementing a parallel diode configuration according to an exemplary embodiment of the present invention;

FIG. 5 is a first state diagram of an exemplary embodiment of the operation of circuitry according to the present invention;

FIG. 6 is a second state diagram of an exemplary embodiment of the operation of circuitry according to the present invention;

The exemplifications set out herein illustrate preferred embodiments of the invention, and such exemplifications are not to be construed as limiting the scope of the invention in any manner.

### DESCRIPTION OF THE PREFERRED EMBODIMENTS

It is a requirement for an integrated receiver decoder (IRD) to meet a 50 dB isolation between inputs when using both of its satellite inputs with traditional outdoor units. Previously this design requirement has been met using either a single high cost absorptive switch IC with roughly 60 dB performance or multiple switch IC's with enough isolation to provide enough margin to guarantee isolation for all conditions and manufacturing/part tolerances. The method and apparatus according to the present invention teaches a way to employ a pair of inexpensive switch IC's by improving isolation using a tuned diode shunt on the potential leakage path that exists between the two inputs when the IRD is in the legacy LNB Mode.

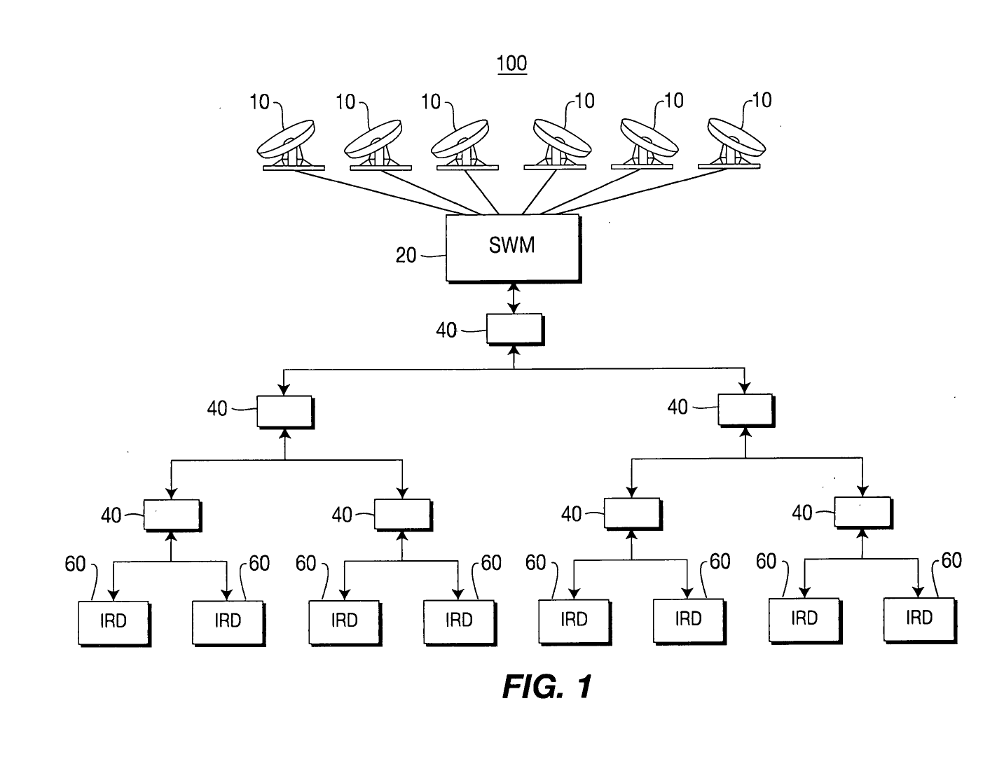

Referring now to the drawings, and more particularly to FIG. 1, a diagram of an exemplary environment 100 for implementing the present invention is shown. Environment 100 of FIG. 1 comprises a plurality of signal receiving means such as signal receiving elements or devices 10, such as parabolic antennas in is exemplary embodiment of the invention, frequency translating means such as FTM 20, a plurality of signal splitting means such as signal splitters 40, and a plurality of signal receiving and decoding means such as IRDs 60. According to an exemplary embodiment described herein, the aforementioned elements of environment 100 are operatively coupled to one another via a transmission medium such as coaxial cable, although other types of transmission mediums may also be used according to the present invention. Environment 100 may for example represent a signal communication network within a given household and/or business dwelling.

Signal receiving elements 10 are each operative to receive signals including audio, video, and/or data signals (e.g., television signals, etc.) from one or more signal sources, such as a satellite broadcast system and/or other type of signal broadcast system. According to an exemplary embodiment, signal receiving element 10 is embodied as an antenna such as a satellite receiving dish, but may also be embodied as any type of signal receiving element.

FTM 20 is operative to receive signals including audio, video, and/or data signals (e.g., television signals, etc.) from signal receiving elements 10, and process the received signals using functions including signal frequency shifting, band pass filtering and frequency translation functions to generate corresponding output signals that are provided to IRDs 60 via coaxial cable and signal splitters 40. According to an exemplary embodiment, FTM 20 may communicate with up to 12 IRDs 60 within a single dwelling. For purposes of example and explanation, however, FIG. 1 shows FTM 20 connected to 8 IRDs 60 using simple two-way signal splitters 40. Further exemplary details regarding FTM 20, and its ability to communicate with IRDs 60 will be provided later herein.

Signal splitters 40 are each operative to perform a signal splitting and/or repeating function. According to an exemplary embodiment, signal splitters 40 are each operative to perform a 2-way signal splitting function to facilitate signal communication between FTM 20 and IRDs 60.

IRDs 60 are each operative to perform various signal receiving and processing functions including signal tuning, demodulation and decoding functions. According to an exemplary embodiment, each IRD 60 is operative to tune, demodulate and decode signals provided from FTM 20 via signal splitters 40, and enable aural and/or visual outputs corresponding to the received signals. As will be described later herein, such signals are provided is from FTM 20 to IRDs 60 responsive to request commands from IRDs 60, and such request commands may each represent a request for a desired band of television signals. With a satellite broadcast system, each request command may for example indicate a desired satellite and/or a desired transponder. The request commands may be generated by IRDs 60 responsive to user inputs (e.g., via remote control devices, etc.).

According to an exemplary embodiment, each IRD 60 also includes an associated audio and/or video output device such as a standard-definition (SD) and/or high-definition (HD) display device. Such display device may be integrated or non-integrated. Accordingly, each IRD 60 may be embodied as a device such as a television set, computer or monitor that includes an integrated display device, or a device such as a set-top box, video cassette recorder (VCR), digital versatile disk (DVD) player, video game box, personal video recorders (PVR), computer or other device that may not include an integrated display device.

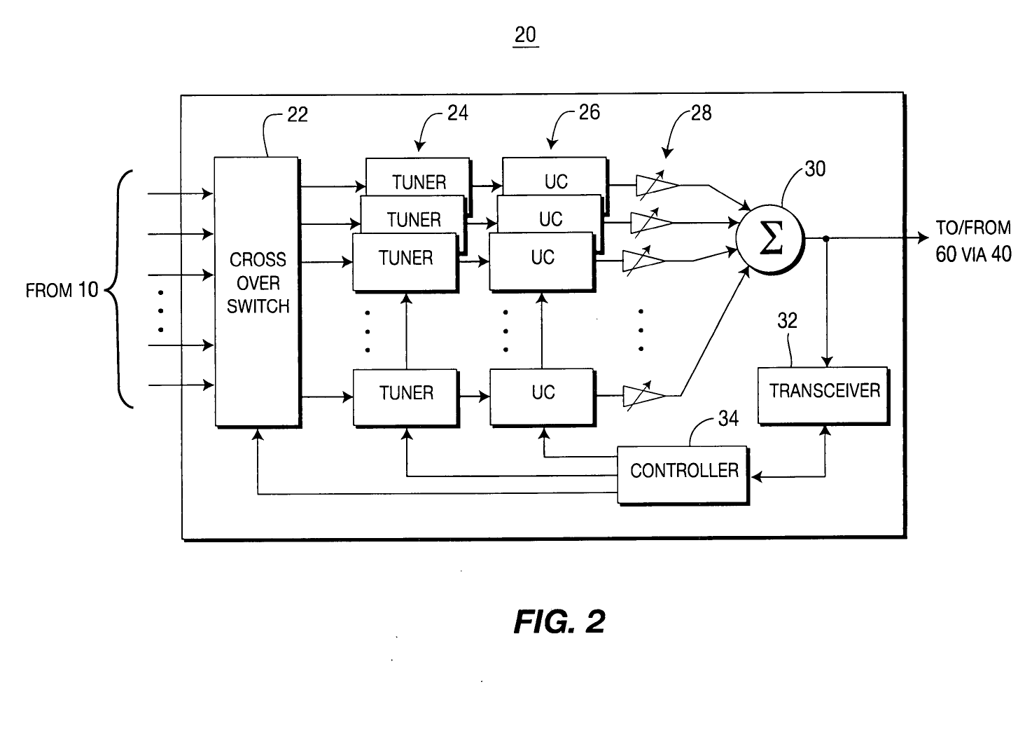

Referring to FIG. 2, a block diagram providing further details of FTM 20 of FIG. 1 according to an exemplary embodiment of the present invention is shown. FTM of FIG. 2 comprises switching means such as cross over switch 22, a plurality of tuning means such as tuners 24, comprising local oscillators and band pass filters, a plurality of frequency converting means such as frequency up converters (UCs) 26, a plurality of amplifying means such as variable gain amplifiers 28, signal combining means such as signal combiner 30, transceiving means such as transceiver 32, and control means such as controller 34. The foregoing elements of FTM 20 may be implemented using integrated circuits (ICs), and one or more elements may be included on a given IC. Moreover, a given element may be included on more than one IC. For clarity of description, certain conventional elements associated with FTM 20 such as certain control signals, power signals and/or other elements may not be shown in FIG. 2.

Cross over switch 22 is operative to receive a plurality of input signals from signal receiving elements 10. According to an exemplary embodiment, such input signals represent various bands of radio frequency (RF) television signals. With a satellite broadcast system, such input signals may for example represent L-band signals, and cross over switch 22 may include an input for each signal polarization used within the system. Also according to an exemplary embodiment, cross over switch 22 selectively passes the RF signals from its inputs to specific designated tuners 24 responsive to control signals from controller 34.

Tuners 24 are each operative to perform a signal tuning function responsive to a control signal from controller 34. According to an exemplary embodiment, each tuner 24 receives an RF signal from cross over switch 22, and performs the signal tuning function by band pass filtering and frequency down converting (i.e., single or multiple stage down conversion) the RF signal to thereby generate an intermediate frequency (IF) signal. The RF and IF signals may include audio, video and/or data content (e.g., television signals, etc.), and may be of an analog signal standard (e.g., NTSC, PAL, SECAM, etc.) and/or a digital signal standard (e.g., ATSC, QAM, QPSK, etc.). The number of tuners 24 included in FTM 20 is a matter of design choice.

Frequency up converters (UCs) 26 are each operative to perform a frequency translation function. According to an exemplary embodiment, each frequency up converter (UC) 26 includes a mixing element and a local oscillator (not shown in FIGS.) that frequency up converts an IF signal provided from a corresponding tuner 24 to a designated frequency band responsive to a control signal from controller 34 to thereby generate a frequency up converted signal.

Variable gain amplifiers 28 are each operative to perform a signal amplification function. According to an exemplary embodiment, each variable gain amplifiers 28 is operative to amplify a frequency converted signal output from a corresponding frequency up converter (UC) 26 to thereby generate an amplified signal. Although not expressly shown in FIG. 2, the gain of each variable gain amplifier 28 may be controlled via a control signal from controller 34.

Signal combiner 30 is operative to perform a signal combining (i.e., summing) function. According to an exemplary embodiment, signal combiner 30 combines the amplified signals provided from variable gain amplifiers 28 and outputs the resultant signals onto a transmission medium such as coaxial cable for transmission to one or more IRDs 60 via signal splitters 40.

Transceiver 32 is operative to enable communications between FTM 20 and IRDs 60. According to an exemplary embodiment, transceiver 32 receives various signals from IRDs 60 and relays those signals to controller 34. Conversely, transceiver 32 receives signals from controller 34 and relays those signals to one or more IRDs 60 via signal splitters 40. Transceiver 32 may for example be operative to receive and transmit signals in one or more predefined frequency bands.

Controller 34 is operative to perform various control functions. According to an exemplary embodiment, controller 34 receives request commands for desired bands of television signals from IRDs 60. As will be described later herein, each IRD 60 may transmit its request command to FTM 20 during a separate time slot that is assigned by controller 34. With a satellite broadcast system, a request command may indicate a desired satellite and/or a desired transponder that provides a desired band of television signals. Controller 34 enables signals corresponding to the desired bands of television signals to be transmitted to corresponding IRDs 60 responsive to the request commands.

According to an exemplary embodiment, controller 34 provides various control signals to cross over switch 22, tuners 24, and frequency up converters (UCs) 26 that cause the signals corresponding to the desired bands of television signals to be transmitted to IRDs 60 via a transmission medium such as coaxial cable. Controller 34 also provides acknowledgement responses to IRDs 60 responsive to the request commands which indicate the frequency bands (e.g., on the coaxial cable, etc.) that will be used to transmit the signals corresponding to the desired bands of television signals to IRDs 60. In this manner, controller 34 may allocate the available frequency spectrum of the transmission medium (e.g., coaxial cable, etc.) so that all IRDs 60 can receive desired signals simultaneously.

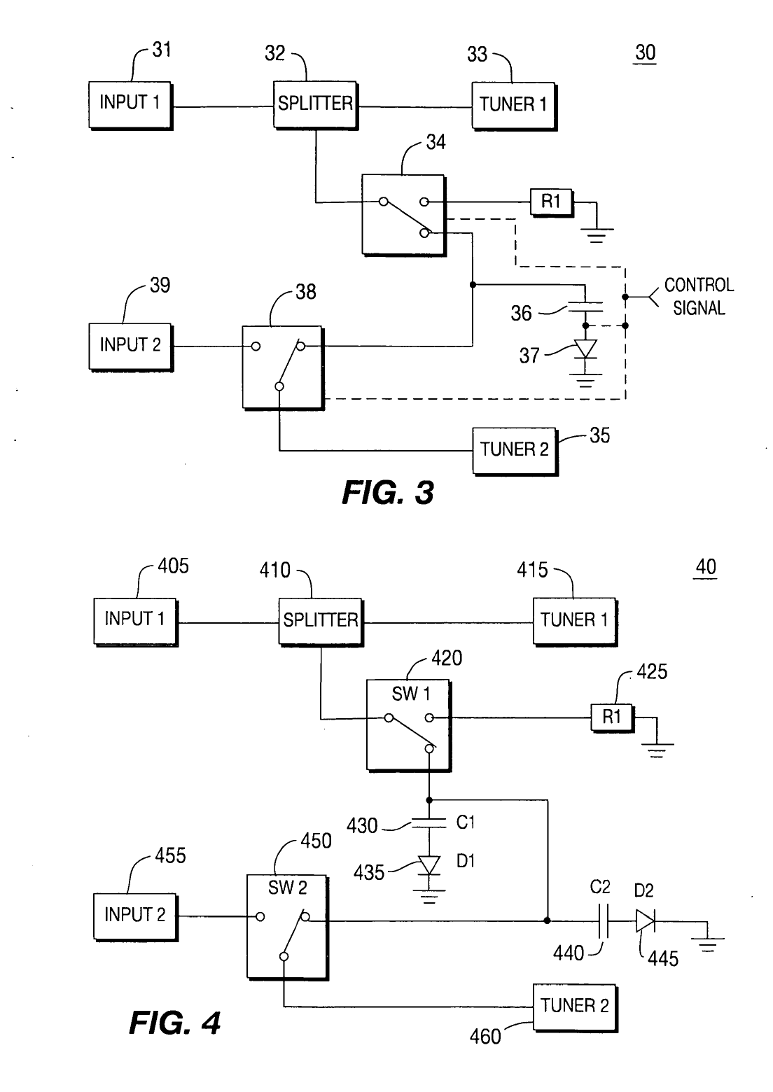

Referring to FIG. 3, a diagram showing further details of the FTM LNB switching circuit 30 implementing a single diode according to an exemplary embodiment of the present invention is shown. The FTM LNB switching circuit 30 comprises a first input 31, a second input 39, a splitter 32, a first tuner 33, a second tuner 35, a first switch 34, a second switch 38, a terminating resistor R1 a capacitor 36 and a shunt diode 37.

In legacy LNB mode, each tuner receives a separate signal via different signal paths. These signal paths are required to be isolated from each other by at least 50 dB over the entire satellite bandwidth. The system couples a first signal from the first input 31 via a splitter 32 to the first tuner 33. The first switch 34 is placed in a state such that the second output of the splitter 32 is coupled to a source of reference potential, such as ground, through a terminating resistor R1. A second signal is received via the second input 39. The second switch 38 is placed in a state such that the second input 39 is coupled through the switch to the second tuner 35. By placing the first switch 34 in a state such that the splitter 32 is coupled to the terminating resistor R1 and the second switch 38 is placed in a state such that the second input 39 is coupled to the second tuner 35, the signal path between the first switch 34 and the second switch 38 is left disconnected from of the tuners 33 35. IN the legacy LNB mode, a control signal is applied to the junction between the capacitor 36 and the diode 37, such that the diode 37 is changed to a conductive state, thereby coupling any signals conducted through the capacitor 36 to a source of reference potential, such as ground. In this exemplary embodiment, the value of the capacitor is selected such that any signal within the satellite bandwidth of 950-2150 MHz is conducted through the capacitor 36, but the control signal applied to the junction of the capacitor 36 and the diode 37 is not coupled through the capacitor 36. The control signal is typically a DC value sufficient to place the diode 37 in a conductive state. Thus, according to an exemplary embodiment of the present invention, the two switches 32 38 isolating the signal path between the switches 32 38 and the coupling of the signal path to a source of reference potential through the capacitor 36 and the diode 37 should be sufficient to meet the isolation requirements required by the IRD.

In FTM mode, the first switch 34 is placed in a state such that the second output of the splitter 32 is coupled to the signal path to the second switch 38. The second switch 38 is placed in a state such that the signal path is coupled to the second tuner 35. Thus the signal received at the first input 31 is conducted to both the first tuner 33 and the second tuner 35. The control signal applied to the junction of the capacitor 36 and the diode 37 is placed in a state such that the diode 37 is rendered non conductive, thereby isolating the source of reference potential from the signal path. The capacitor 36 is further chosen such that it is operative to ensure that no DC signal present on the signal path is operative to place the diode 37 in a conductive state.

Referring to FIG. 4, a diagram showing further details of the FTM LNB switching circuit 30 implementing a parallel diode configuration according to an exemplary embodiment of the present invention is shown. The FTM LNB switching circuit 40 comprises a first input 405; a second input 455, a splitter 410, a first tuner 415, a second tuner 460, a first switch 420, a second switch 450, a terminating resistor 425, a first capacitor 430, a first shunt diode 435, a second capacitor 440 and a second shunt diode 445.

In legacy LNB mode, as with the previous exemplary embodiment shown in FIG. 4, each tuner receives a separate signal via different signal paths. These signal paths are required to be isolated from each other by at least 50 dB over the entire satellite bandwidth. The system couples a first signal from the first input 405 via a splitter 410 to the first tuner 415. The first switch 420 is placed in a state such that the second output of the splitter 410 is coupled to a source of reference potential, such as ground, through a terminating resistor 425. A second signal is received via the second input 455. The second switch 450 is placed in a state such that the second input 455 is coupled through the switch to the second tuner 460. By placing the first switch 420 in a state such that the splitter 410 is coupled to the terminating resistor 425 and the second switch 450 is placed in a state such that the second input 455 is coupled to the second tuner 460, the signal path between the first switch 420 and the second switch 450 is left disconnected from of the tuners 415 460. In the legacy LNB mode, a control signal is applied to the junction between the first capacitor 430 and the first diode 435, such that the first diode 435 is changed to a conductive state, thereby coupling any signals conducted through the first capacitor 430 to a source of reference potential, such as ground. According to the second exemplary embodiment, the control signal is also applied to the junction between the second capacitor 440 and the second diode 445, such that the second diode 445 is changed to a conductive state, thereby coupling any signals conducted through the second capacitor 440 to a source of reference potential. The according to the second exemplary embodiment according to the present invention, the signal path is coupled two the source of reference potential at two points, thereby increasing the isolation between the first and second tuners 415 460. In this exemplary embodiment, the value of the capacitors 430 440 are selected such that any signal within the satellite bandwidth of 950-2150 MHz is conducted through the capacitors 430 440, but the control signal applied to the junction of the capacitors 430 440 are and the diodes 435 445 is not coupled through the capacitors 430 440. The control signal is typically a DC value sufficient to place the diodes 435 445 in a conductive state. Thus, according to an exemplary embodiment of the present invention, the two switches 420 450 isolating the signal path between the switches 420 450 and the coupling of the signal path to a source of reference potential through the capacitors 430 440 and the diodes 435 445 should be sufficient to meet the isolation requirements required by the IRD.

In FTM mode, the first switch 420 is placed in a state such that the second output of the splitter 410 is coupled via the signal path to the second switch 450. The second switch 450 is placed in a state such that the signal path is coupled to the second tuner 460. Thus the signal received at the first input 405 is conducted to both the first tuner 415 and the second tuner 460. The control signal applied to the junction of the capacitors 430 440 and the diodes 435 445 is placed in a state such that the diodes 435 445 are rendered non conductive, thereby isolating the source of reference potential from the signal path. The capacitors 430 440 are further chosen such that it is operative to ensure that no DC signal present on the signal path is operative to place the diodes 435 445 in a conductive state.

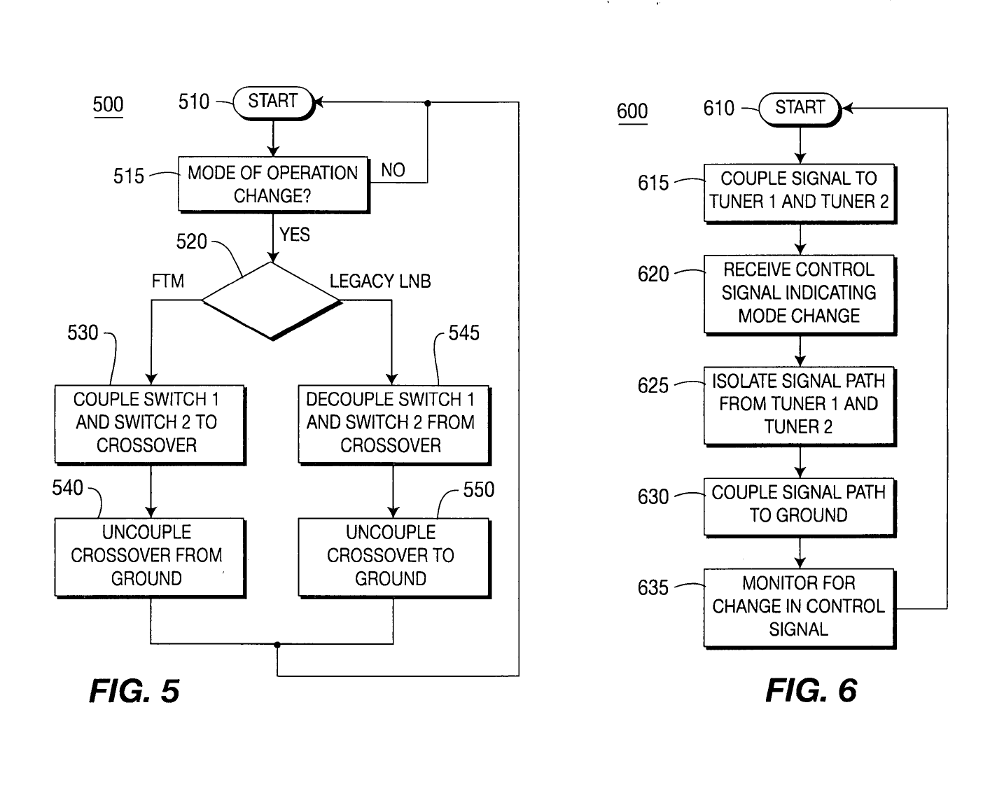

FIG. 5 is a first state diagram 500 of an exemplary embodiment of the operation of circuitry according to the present invention. In the exemplary embodiment, the circuitry it is predetermined to initialize the IRD in the Legacy mode. However, It should be appreciated that this selection is design dependent and either the Legacy or FTM modes may be chosen for initialization and both initialization arrangements are in accordance with principles of the present invention.

At step 510, the system runs in a previously selected operating mode. The processor continuously monitors the system for a change of operation signal 515. When a change of mode of operation signal is received, the system then determines if the new mode is the legacy LNB mode or the FTM mode 520. If the FTM mode is selected, the system then alters the control signal as appropriate for the FTM mode and couples switch 1 and switch 2 over to the crossover 530, thereby completing the signal path between the first input and the second tuner as shown in FIGS. 4 and 5. At step 540, the system further alters the control signal to ensure that the signal path is decoupled from the source of reference potential. While the present embodiment uses separate control signals to control the switches and the coupling to reference potential, these operations could be performed by a single control signal. The system then returns to the wait state 510 and monitors for a change of mode of operation.

If at step 520, the change of mode of operation indicates that the legacy LNB mode is requested, the system then alters the control signal such that the first switch and the second switch are decoupled from the signal path 545 such that the first input and the second tuner are isolated from each other. The system then alters the control signal to ensure that the signal path is coupled to ground 550, thereby conducting any unwanted crossover signals to ground thereby enhancing the required isolation between the first tuner and the second tuner. While the present embodiment uses separate control signals to control the switches and the coupling to reference potential, these operations could be performed by a single control signal. The system 500 then returns to the wait state 510 and monitors for a change of mode of operation.

FIG. 6 is a second state diagram 600 of an exemplary embodiment of the operation of circuitry according to the present invention. In the exemplary embodiment, the circuitry it is predetermined to initialize the IRD in the FTM mode. However, It should be appreciated that this selection is design dependent and either the Legacy or FTM modes may be chosen for initialization and both initialization arrangements are in accordance with principles of the present invention.

At initialization, 610 the system sets the control signal such that the system is in the FTM mode. The system then couples the signal received at the first input to the first and second tuners 615. The system then monitors for a request for a change in mode 620. The system then proceeds to isolate the signal path from both tuner 1 and tuner 2 625. The system then couples the signal path to ground in response to the change in control signal 630 The system then returns to a monitoring state 635, waiting for a request to change to the FTM mode. When that request is received, the system returns to the initialization step 610. The system then receives At the wait state 610, the system monitors for a request to change the mode of operation.

As described herein, the present invention provides an architecture and protocol for enabling signal communications between an FTM and an IRD within a dwelling. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus comprising:
a first input;
a first signal processing circuit;
a first switch;
a signal path; and
a splitter for coupling a signal from said input to said first signal processing circuit and said switch, said first switch being operative to couple said signal to said signal path during a first mode of operation, said first switch being further operative to isolate said signal from said signal path during a second mode of operation; wherein said signal path is coupled to a source of reference potential during said second mode of operation and isolated from said source of reference potential during said first mode of operation

2. The apparatus of claim 1 further comprising a first diode coupled at a junction of said signal path between a source of reference potential and said signal path, said first diode operative to couple said junction to said source of reference potential in said first mode of operation.

3. The apparatus of claim 2 further comprising a second diode coupled between a source of reference potential and said signal path, said second diode operative to couple said junction to said source of reference potential in said first mode of operation.

4. The apparatus of claim 2 wherein said first diode is coupled to said signal path through a first capacitor.

5. The apparatus of claim 1 further comprising a second switch operative to couple said signal path to a second signal processing circuit during said first mode of operation and alternately to isolate said second signal processing circuit from said signal path during said second mode of operation.

6. The apparatus of claim 5 wherein said second switch is operative to couple said second signal processing circuit to a second input during said second mode of operation.

7. The apparatus of claim 5 wherein said first switch, said second switch and said first diode are responsive to a first control signal, said first control signal being at a first level during said first mode of operation and a second level during said second mode of operation.

8. A method comprising:
receiving a first signal from a first source during a first mode of operation and a second mode of operation;
receiving a second signal from a second source during a second mode of operation;
coupling said first signal to a first signal processor and a second signal processor during a first mode of operation; and
coupling said first signal to said first signal processor and said second signal to said second signal processor and coupling a junction between said first source and said second signal processor to a source of reference potential during a second mode of operation.

9. The method of claim 8 further comprising the step of isolating said first source from said junction and said signal processor from said junction during said second mode of operation.

10. The method of claim 8 wherein said junction is coupled to said source of reference through a diode.

11. The method of claim 10 wherein said first diode is coupled to said junction through a first capacitor.

12. An apparatus comprising:
a signal path, said signal path being coupled between a signal source and a tuner during a first mode of operation and being isolated from said signal source and said tuner during a second mode of operation, wherein said signal path is further coupled to a source of reference potential during said second mode of operation and being isolated from said source of reference potential during said first mode of operation.

13. The apparatus of claim 12 further comprising a first diode coupled between a source of reference potential and said signal path, said first diode operative to couple said junction to said source of reference potential in said first mode of operation.

14. The apparatus of claim 13 further comprising a second diode coupled between a source of reference potential and said signal path, said second diode operative to couple said junction to said source of reference potential in said first mode of operation.

15. The apparatus of claim 13 wherein said first diode is coupled to said signal path through a first capacitor.

16. A method comprising:
coupling a first signal to a first signal processing circuit via a first signal path and to a second signal processing circuit via a second signal path;
receiving a control signal;
coupling a second signal to said second signal processor via a third signal path in response to said control signal;
isolating said second signal path from said second signal processing circuit in response to said control signal; and
coupling said second signal path to a source of reference potential in response to said control signal.

17. The method of claim 16 wherein said second signal path is coupled to said source of reference through a diode.

18. The method of claim 17 wherein said first diode is coupled to said junction through a first capacitor.

19. The method of claim 16 wherein said first signal is received via a first antenna and said second signal is received via a second antenna.

20. The method of claim 16 wherein said second signal processing circuit is isolated from said first signal processing circuit in response to said control signal.
